(19) United States
(12) Patent Application Publication
(10) Pub. No.: US 2019/0011026 A1
(43) Pub. Date: Jan. 10, 2019

(54) LINEAR ACTUATOR BASED ON RUGGEDIZED PLANETARY SCREW

(71) Applicant: Delbert Tesar, Austin, TX (US)

(72) Inventor: Delbert Tesar, Austin, TX (US)

(21) Appl. No.: 15/726,376

(22) Filed: Oct. 5, 2017

Related U.S. Application Data
(60) Provisional application No. 62/404,739, filed on Oct. 5, 2016.

(51) Int. Cl. F16H 25/22

(52) U.S. Cl. CPC F16H 25/2252; F16H 2025/2078

(57) ABSTRACT

A planetary screw actuator is provided which includes a stator; a rotor; a lead screw having external threads thereon; an ovoidal planet screw that meshes with the external threads on the lead screw; an end plate; and a grooved roller bearing (GRB) race disposed between the end plate and the ovoidal planet screw. The GRB race has at least one GRB roller disposed therein.

### CROSS-REFERENCE TO RELATED APPLICATIONS

The present application claims priority to provisional application U.S. 62/404,739 (Tesar), entitled “LINEAR ACTUATOR BASED ON RUGGEDIZED PLANETARY SCREW”, which is incorporated herein by reference in its entirety.

### FIELD OF THE DISCLOSURE

The present disclosure relates generally to electromechanical actuators, and more particularly to linear actuators which utilize a ruggedized planetary screw.

### BACKGROUND OF THE DISCLOSURE

Planetary roller screw actuators (also known as a roller screw actuators or satellite roller screw actuators) are a class of linear actuators. These low-friction, precision, screw-type actuators convert rotational motion to linear motion, or vice versa.

Planetary roller screw actuators are used as the actuating mechanism in many electro-mechanical linear actuators. As a result of their complexity, roller screw actuators are relatively expensive actuators, and frequently cost an order of magnitude more to manufacture than their ball screw counterparts. However, roller screw actuators are frequently the actuator of choice for applications which require high-precision, high-speeds, heavy-loads, long-lives and heavy-use.

An early example of a planetary roller screw actuator is disclosed in U.S. Pat. No. 2,683,379 (Strandgren), which is reproduced in FIG. 19 hereof. The dynamic equations for the motion of planetary screw mechanisms have been discussed in the art and may be found, for example, in Matthew H. Jones, Steven A. Velinsky and Ty A. Lasky, “Dynamics of the Planetary Roller Screw Mechanism”, J. Mechanisms Robotics 8 (1), 014503 (Aug. 18, 2015).

FIG. 13 depicts a planetary screw drive which is commercially available from Schaeffler Technologies AG. As seen therein, the planetary screw drive 101 depicted is equipped with a central spindle 103 having a helically grooved surface 105. A retaining ring 107, planetary disk 109 and a series of planets 111 are disposed about the central axis of the spindle 103, along with a pair of nuts 113 equipped with a spacer disc 115. This planetary screw drive 101 purportedly delivers both a high load carrying capacity and a high power density, and may be used as a substitute for hydraulic drives.

The planetary screw drive 101 design features planetary gears with v-shaped parallel grooves that roll up and down the spindle. The rotation of these planetary gears and the planetary screw drive is ensured by the two-piece screw drive nut, which also has grooves at the ends that engage with the ends of the planetary gears. The high power density of the planetary screw drive 101 is said to allow it to be used as an alternative to hydraulic drives.

The very high number of rolling contacts is said to allow the planetary screw drive 101 to achieve a higher load carrying capacity and rigidity than ball screw drives or roller screw drives. Friction levels are said to remain low thanks to good internal load distribution and the optimized osculation between the spindle thread flanks and the crowned flanks of the planetary gear grooves. When planetary gears with the correct groove diameter are selected, overall pitches of just 0.75 to 5 mm can purportedly be achieved with this drive.

The advantages of the design of the planetary screw drive 101 are said to extend to the manufacturing process itself. In particular, the spindles and planetary gears are manufactured using forming methods, which is said to make good material compression possible together with optimum grain flow, the highest possible strength, and a further 15% increase in load rating compared to conventional technologies. This manufacturing method is also said to reduce the costs to a level comparable with that of ball screw drives manufactured using forming methods. Clearance free, preloaded units are said to be easily be created by adding a spacer washer between the two halves of the spindle nut.

A high number of rolling contacts means that the planetary screw drive 101 achieves a higher load carrying capacity and rigidity. Friction levels are said to remain low due to good internal load distribution and the optimized osculation between the spindle thread flanks and the crowned flanks of the planetary gear grooves. When planetary gears with the correct groove diameter are selected, overall pitches of just 0.75 mm to 5 mm purportedly can be achieved. The planetary screw drive 101 is said to generate 200 N of axial force from just 40 Ncm, with an overall pitch of 0.75 mm. As a result, very high axial forces can purportedly be achieved with the drive using small electric motors.

U.S. 2016/0226337 (Rudy) discloses a recent example of a planetary roller screw actuator which incorporates a screw drive. The linear actuator disclosed therein, which is reproduced in FIG. 12, includes an electric motor having a stator and a rotor, in addition to a screw drive having a spindle and a nut which is guided by the rolling element on the spindle and which is coupled to the rotor. The nut is mounted in a rotationally fixed manner on a housing component by a planetary roller bearing.

The linear actuator 1 of Rudy includes an electric motor 2 with a stator 3 and a rotor 4. The rotor 4 is constructed as a hollow component. It is supported so that it can rotate by a radial bearing 5 (here a ball bearing) on a housing component 6 that is fixed on the stator side. The rotor 4 has a hollow section 7 that forms a nut 8 that is part of a screw drive that is here constructed as a planetary rolling contact gear 9. The section 7 is constructed such that it is located for the most part in the interior of the stator 3. Consequently, the screw drive is also located almost entirely in the interior of the stator.

The planetary rolling contact gear 9 comprises two outer rings 10 that are held rotationally locked in nut 8 and have corresponding grooves on their inner sides. Also provided are multiple planets 11 that are held in corresponding spacer washers 12 with their end sides. The planets 11 have two end sections that are likewise provided with grooves and mesh with the grooves of the outer rings 10. A middle section (somewhat larger in diameter) also has grooves that mesh on their side with the groove of a spindle 13. The groove of the spindle 13 has a pitch, and consequently is constructed as a thread. A rotation of the nut 8 thus leads to a rotation of the planets 11, which necessarily leads to an axial movement of the spindle 13 due to the thread shape of the spindle-side groove. In the interior of the nut 8 are two bearing washers 14 on which the support washers 12 are supported.

The section 7 (i.e., nut 8) extends a distance out from the stator 3. Adjacent to the stator 3, the nut 8 is supported on a housing component 16 of the linear actuator 1 by a planetary rolling contact bearing 15. The nut 7 quasi represents the inner ring of the planetary rolling contact bearing 15. It has a corresponding groove shape on its outer side, wherein the planets 17 of the planetary rolling contact bearing 15, which naturally also have corresponding grooves, roll in these grooves. An outer ring 18 of the planetary rolling contact bearing 15, which also has grooves in which the planets 17 roll, is held in a shape-compatible recess 19 of the housing component 16 and fixed accordingly by another housing component 20. Through the use of the planetary rolling contact bearing 15, the nut 8 and thus the rotor 4 itself (which is formed integrally with the nut 8) is supported radially on this side, and also supported axially, because the planetary rolling contact bearing 15 is simultaneously used as an axial bearing. It is in the position to receive considerable axial forces, according to which a plurality of corresponding planets 17 are arranged distributed around the circumference. Here, the planets are naturally also held in corresponding spacer washers 21 that are in turn supported by corresponding retaining washers 22.

### BRIEF DESCRIPTION OF THE DRAWINGS

FIG. 1 is an illustration of a particular, non-limiting embodiment of a ruggedized planetary screw (RPS) actuator in accordance with the teachings herein.

FIGS. 2a-2b are illustrations of a geometric analysis of the RPS and augmented RPS (ARPS). FIG. 2a depicts the reduction from nut to screw, and FIG. 2b depicts the reduction from the star compound gear.

FIG. 3 is an illustration of a particular, non-limiting embodiment of an augmented ruggedized planetary screw (ARPS) actuator in accordance with the teachings herein.

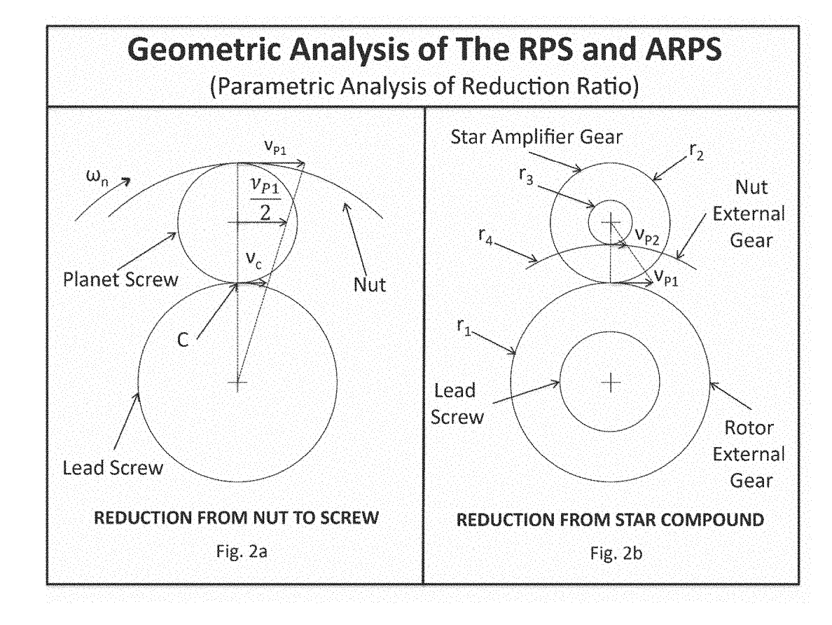

FIGS. 2a-2b are perspective views of a particular, non-limiting embodiment of a stator for an EPS in accordance with the teachings herein. FIG. 4a depicts a full view of the stator, and FIG. 4b depicts a cross-sectional view of the stator taken along LINES 4a-4a of FIG. 4a.

FIGS. 5a-5b are perspective views of a particular, non-limiting embodiment of a rotor for an EPS in accordance with the teachings herein. FIG. 5a depicts a full view of the rotor, and FIG. 5b depicts a cross-sectional view of the rotor taken along LINES 5a-5a of FIG. 5a.

FIGS. 6a-6b are perspective views a particular, non-limiting embodiment of a planetary screw for an EPS in accordance with the teachings herein. FIG. 6a depicts a full view of the planetary screw, and FIG. 6b depicts a cross-sectional view of the planetary screw taken along LINES 6a-6a of FIG. 6a.

FIGS. 7a-7b are perspective views of a particular, non-limiting embodiment of an expanded planetary screw (EPS) endplate in accordance with the teachings herein. FIG. 7a depicts a full view of the EPS, and FIG. 6b depicts a cross-sectional view of the EPS taken along LINES 7a-7a of FIG. 7a.

FIG. 8a is an illustration of an internal ovoidal screw (IOS).

FIG. 8b is an illustration of an external ovoidal screw (EOS).

FIG. 8c is an illustration of a grooved roller bearing.

FIG. 8d is an illustration of a tongue/groove spline.

FIG. 9 is a listing of some attributes of grooved roller bearings.

FIGS. 10a-10c are a series of illustrations of a high load capacity spindle screw transmission. FIG. 10a is a perspective view of the spindle screw transmission, FIG. 10b is a side view of the spindle screw depicting the screw pitch curve thereof, and FIG. 10c is a side view depicting a cross-sectional view of the spindle screw taken along LINES 10a-10a thereof, and with a portion of the housing removed.

FIG. 11 is a listing of some attributes of a high load capacity spindle screw transmission.

FIG. 12 is a cross-sectional view of a prior art linear actuator.

FIG. 13 is a perspective view of a prior art linear actuator.

### SUMMARY OF THE DISCLOSURE

In one aspect, a planetary screw actuator is provided which comprises (a) a stator; (b) a rotor; (c) a lead screw having external threads thereon; (d) an ovoidal planet screw that meshes with the external threads on the lead screw; (e) an end plate; and (f) a grooved roller bearing (GRB) race disposed between said end plate and said ovoidal planet screw, said GRB race having at least one GRB roller disposed therein.

### DETAILED DESCRIPTION

While the planetary roller screw actuator of U.S. 2016/0226337 (Rudy) may have some desirable features, it also suffers from some infirmities. This actuator uses a grooved roller bearing to carry the principal thrust load for the actuator, and the lead screw is prevented from rotation with a constraint. The “rolling contact gear” disclosed in this reference is a grooved roller bearing (GRB) constraint with no lead in the grooved rolling element. The planetary screws use a GRB element on each end of smaller diameter with a larger diameter grooved element in the center to mesh with the lead screw and the inside of the nut (driven directly by the rotor). These grooves have no lead, so the planetary spindles do not move horizontally relative to the nut. Consequently, the load goes from the lead screw to two meshes on the planetary spindle to the nut, which transfers the load from the grooved roller bearing to the stator which acts as reference. This is the normal long load path for the SPS (Standard Planetary Screw) linear reducer. Similarly, the planet spindles in the device of Rudy have no lead, a configuration which results in an undesirable lengthening of the force path.

It is a goal of the present disclosure to improve electro-mechanical actuators to ensure effective replacement of hydraulics and satisfy a very wide range of application requirements. This may be accomplished by modernizing the well-established, but parametrically limited, planetary screw transmission in a cost-effective and high force/power dense configuration.

Linear actuation has been dominated by hydraulic cylinder drivers. This is especially true in heavy construction machinery, where shock is an issue and where force density (low power duty cycles) is the principal design objective. Unfortunately, hydraulic drivers have a poor durability history, and require considerable maintenance. Hydraulic drivers also tend to leak, are very inefficient, and are not responsive to command (the latency is 300 to 500 msec.).

Advances in electro-mechanical technologies (controllers, prime movers, sensors, bearings, condition-based maintenance, and the like) have made possible a new class of electrical linear actuators. This began with a mechanical transmission that was first developed in the 1940's, and that was patented by C. B. Strandgren in 1954 as a spindle screw drive. This drive featured a rotating “nut” with internal threads (of zero lead) that mesh with planet spindles (of zero lead) that, in turn, drive a translating (not rotating) lead screw with a lead lₛ of between 0.075 and 1-to-1 (in/R) relative to the rotation of the nut (i.e., a reduction ratio range of 15, at best). Unfortunately, the thread mesh with the lead screw represents a high rolling velocity and the load path is long, going through two thread meshes with low stiffness, high lost motion, and poor shock resistance. Today, this unit is produced by Rollvis (Switzerland), SKF (Sweden) and Creative Motion Control (U.S.).

It has now been found that some or all of the foregoing infirmities may be overcome with the systems, devices and methodologies disclosed herein. In one embodiment, a spindle/lead screw mesh is provided that may carry a high load with a reasonable range of lead values based on the number of threads nₛ and the lead lₛ of each thread. This range may vary from 1/15 to ⅓, or a difference of 5. The driving nut, in this case, is an integral part of the rotor to reduce parts and simplify the structure. The radii rₛ of the lead screw and the radii rₚ of the planet screw result in approximately another reduction of 5 to 1 to give a total reduction of 1/75 to 1/15. The nut which drives the planets and directly carries the output load is supported at each end by the remarkable grooved roller bearing, which can carry 15× more thrust loads than tapered roller bearings of similar size. These bearings are thus supported at each end by end plates rigidly attached to the stator which acts as the structural backbone of the actuator. This arrangement makes the actuator unusually rugged and shock tolerant, and ideal for linear actuators of high force density duty cycles. Further, the planet screw may be produced with an ovoidal shape to dramatically reduce the lost motion in load reversals at, perhaps, a 10% cost premium.

Electro-mechanical actuators based on the Rugged Planetary Screw (RPS and ARPS) may provide some remarkable benefits. Some of these benefits are set forth in TABLE 1 below.

TABLE 1
Some Advantages of EMAs Based on RPS and ARPS

| Attribute | Effect | Advantage |
|---|---|---|
| Reduction Ratio | From 5 up to 75-to-1 | Range of 15 |
| Applications | High Force/Power Density | Light/Heavy Duty Cycle |
| Mesh Sliding | Almost None | Less Wear/Less Friction |
| Load Capacity | Up to 5x More | Parallel Load Paths |
| Load Path | Shortest Possible | Screw Mesh Thru GRB |
| Stiffness | Exceptional Shock | Concentric Structural |
| | Resistance | Symmetry |
| Backlash | Ovoidal Screw Mesh | No Backlash/Low Lost |
| | | Motion |
| Responsiveness | Minimal Moving Mass | Perhaps in 10 m-sec |

Emerging machine elements may be utilized in the systems, devices and methodologies disclosed herein in order to make electro-mechanical linear actuators functionally competitive with their equivalent rotary actuators. This involves linear modules that plug-in where hydraulic/pneumatic actuators are now used with increased emphasis on force and power density duty cycles.

Rotary actuators are ubiquitous where they drive cranks that are the inputs to functional machines. Linear actuators are ubiquitous where they drive cranks that are outputs as in, for example, the articulated scoops of earth excavators. This distinct functional geometry makes it difficult to directly plug-in a rotary actuator where linear actuators are traditionally used. To do so would require considerable structural redesign (although in many cases, it may be justified if the rotary EMA offers sufficient benefits).

Normally, linear actuators are hydraulic or pneumatic. Both types of actuators have various drawbacks, including limitations in durability and responsiveness, and the requirement of excess maintenance. By contrast, rotary EMAs are widely used in industrial robots under high power density duty cycles with a life durability of 100,000(+) hours. To develop a linear EMA of that durability, power density, and sufficiently low weight has heretofore been a very high challenge.

Fortunately, several emerging machine design elements (including grooved roller bearings and ovoidal screws) have now become available to enable a new class of linear EMAs that are either force or power dense (low weight), with high output stiffness, high responsive to command, shock resistance and efficiency, and with a reasonable set of design choices to meet a wide range of application requirements.

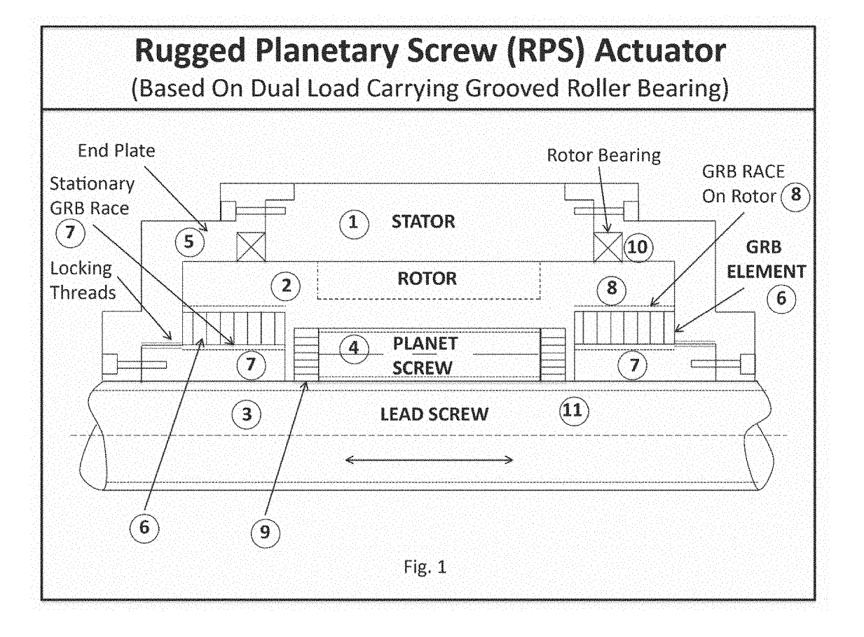

FIG. 1 illustrates a first particular, non-limiting embodiment of a rugged planetary screw actuator in accordance with the teachings herein. Preferably, the drives disclosed herein offer simplicity to expand the load capacity, stiffness, and lost motion as shown below by replacing the straight planetary screws with those that are slightly ovoidal. These ovoidal planet screws mesh with both the internal threads on the nut with no lead (lₚ=0), as well as with the external threads of the translating (non-rotating) output lead screw with a lead of lₛ. In general, the number of threads nₛ of the lead screw provides a total lead of the planetary screw rotation to the driving nut of:

$${R}_{ns} = \frac{4 π ( {r}_{s} + {r}_{p} )}{{n}_{s} {𝓁}_{s} ( {r}_{s} + 2 {r}_{p} )} \qquad ( EQUATION 1 )$$

where

rₛ—radius of the lead screw

rₚ—radius of the planet screw

nₛ—number of lead screw threads

lₛ—the lead of each lead screw thread

The reduction can be as high as 80 to 1 (i.e., 80 nut rotations for each inch of travel of the lead screw. Note that the nut contains an internal gear to mesh with external gears at each end of the planet screws to enforce the timing of the planets to maintain rolling contact on the lead screw.

The cross-section of the Rugged Planetary Screw (RPS) actuator in FIG. 1 shows that the stator/rotor surrounds the planetary screw transmission where the rotor and nut are one rigid rotating cylinder. The stator is on the outer surface of the actuator to facilitate cooling it while also allowing the stator to act as the structural backbone of the actuator. The stator is unusually stiff (it is preferably equipped with a solid, laminated structure), which ties the two end plates together to result in rugged support for the thrust load carrying grooved roller bearings. These end plates provide convenient attachment points for the actuator.

The two linear or ovoidal planet screw meshes between the nut and the lead screw transfer the thrust load from the lead screw to the rugged nut/rotor combination and then through the GRB elements to the end plates of the actuator. These end plates are attached to the inner GRB race with lock threads and a lock bolt. The end caps are threaded onto the lock threads by rotating until the assembly is tight, at which time the lock bolts are inserted and the end plate bolts are driven into the stator. The nut/rotor also contains dual internal gears to mesh with external gears on each end of the planet screws to ensure rolling contact between the planet and lead screws. Overall, this rugged planetary screw actuator represents exceptional simplicity which may serve to maximize stiffness and reduced lost motion, while still being relatively inexpensive to manufacture.

The RPS may be further understood by considering the reduction between the rotation r of the rotor/nut and the translation s of the lead screw. This reduction is given by:

$$R = \frac{Δ s}{Δ r} in / rotation \qquad ( EQUATION 2 )$$

For example, if the output is to be 60 in/min. and the motor speed is to be 6000 RPM, then the reduction would be 100 or 0.01 in. per motor rotation, which is a very high reduction ratio.

In FIG. 2a, the nut at ωₙ drives the planet screw in rolling contact to provide:

V_{PI}=(rₛ+2rₚ)φₙ (EQUATION 3)

Since rolling contact between the planets and lead screw is enforced by the planet gears, point c represents no sliding motion and the center of the planet screw has the velocity vₚ₁/2. Then, the contact point moves along the lead screw surface at the velocity:

$${v}_{c} = \frac{{r}_{s} ( {r}_{s} + 2 {r}_{p} )}{2 ( {r}_{s} + {r}_{p} )} {ω}_{m} \qquad ( EQUATION 4 )$$

Accounting for the lead screw reduction of nₛ lₛ, the total reduction ratio is:

$$R / {R}_{ns} = \frac{4 π ( {r}_{s} + {r}_{ps} )}{{n}_{s} {𝓁}_{s} ( {r}_{s} + 2 {r}_{p} )} \qquad ( EQUATION 5 )$$

Using the following numbers,

nₛ=1,lₛ= 1/15,rₛ=0.9,rₚ=0.3

then

Rnₛ=100.5

which is a very suitable high reduction ratio. Letting lₛ=⅛, then

Rnₛ=53.6.

For output speed of 60 in/sec., this then requires a nut/rotor speed of 3200 RPM, which is quite reasonable for a rugged actuator design.

From a load path perspective, the thrust load goes through only one planet screw mesh directly to the GRB at each end of the planet screws to dramatically reduce deformation and likely improve load capacity. To evaluate this load transfer, we need to look at the concept of horsepower at the prime mover and at the output lead screw, or

$$H . P . = \frac{{F}_{s} {V}_{s}}{33 , 000} = \frac{{T}_{m} {ω}_{n}}{63025} \qquad ( EQUATION 6 )$$

where
Fₛ—lb.
Vₛ—in/min.
Tₘ—in/lb.
ωₙ—RPM
   Note that:

Vₛ=lₚₛωₙ (EQUATION 7)

where lₚₛ is the total reduction ratio of the system given in EQUATION 5.

From EQUATION 4, we have:

Tm=0.01326Fₛlₚₛ (6)

where lₚₛ is given in in/R (R represents one turn at the prime mover).
To clarify these symbols:
Tₘ—motor torque in ft-lb.
Fₛ—load force on the lead screw in lb.
lₚₛ—the mechanical lead of the output screw in inches relative to one rotation of the rotor.

Given a reduction of 53.6, then the torque Tₘ with a load Fs=80,000 lb. would be:

$$\begin{matrix}{T}_{m} = \frac{0.01326 \times 80 , 000}{53.6} \\ = 19.8 ft \text{-} lb .\end{matrix}$$

Normally, these systems have an efficiency of 75%, so the actual input torque would be 26.5 ft-lb. In this case, the peak load occurs for only 10 sec., so the duty cycle is very modest, and hence heating is not a concern. Given motor torque capacity of 1 ft-lb/lb. means that the motor would weigh only 26.5 lb.

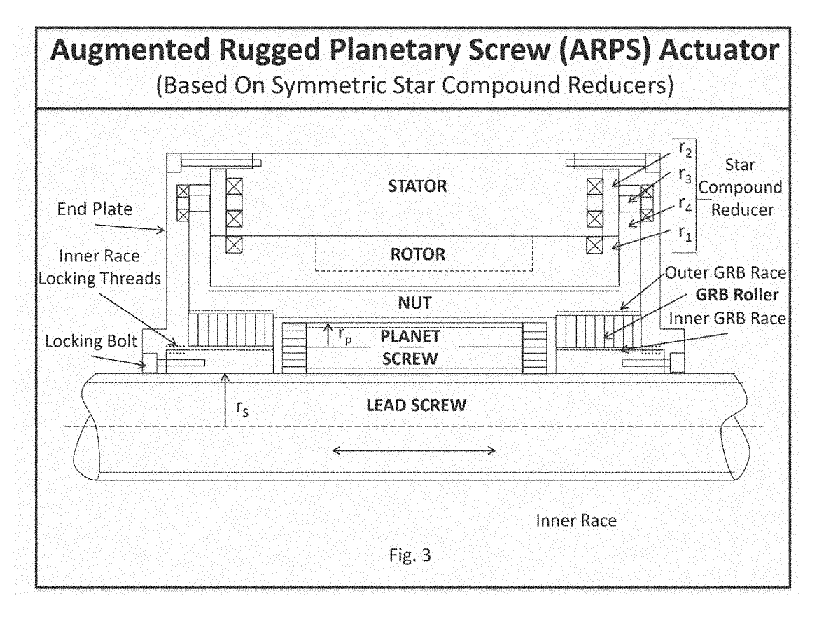

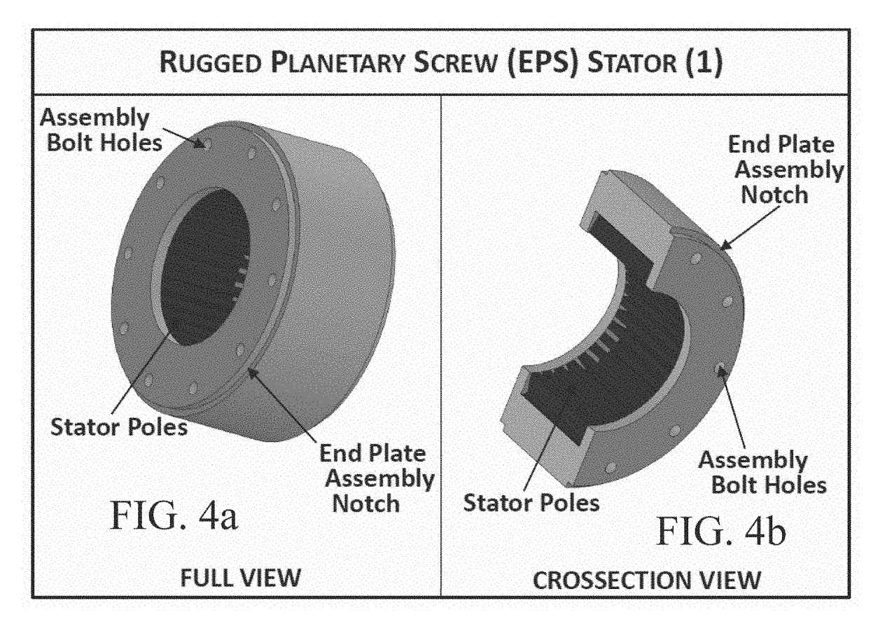

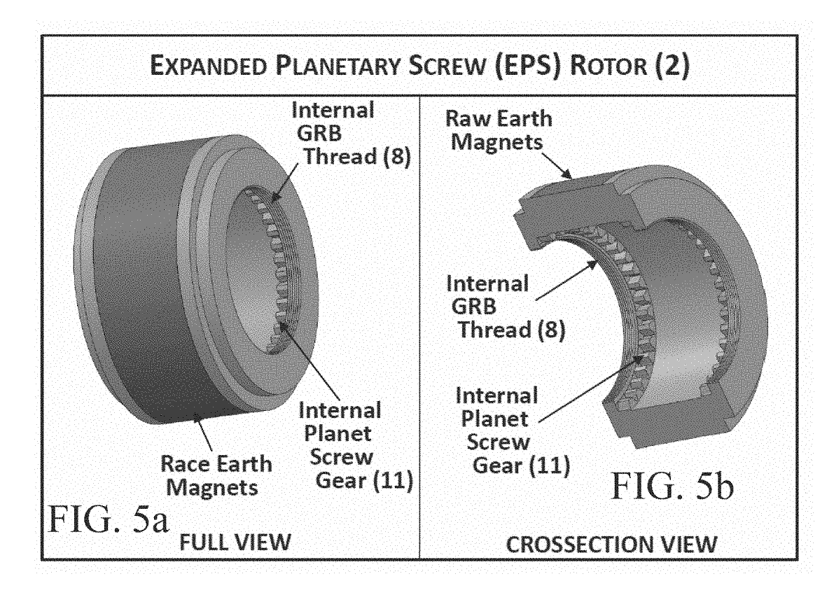

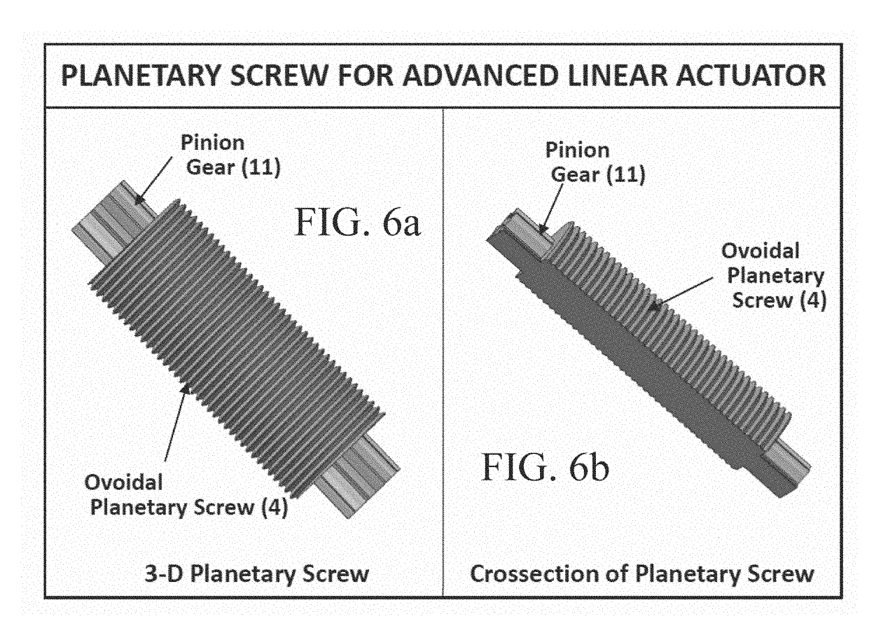

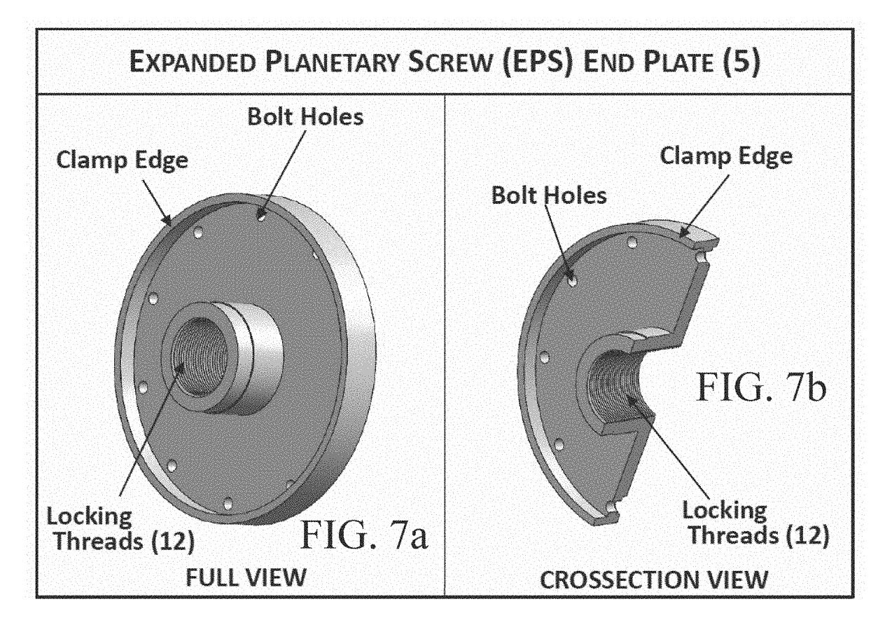

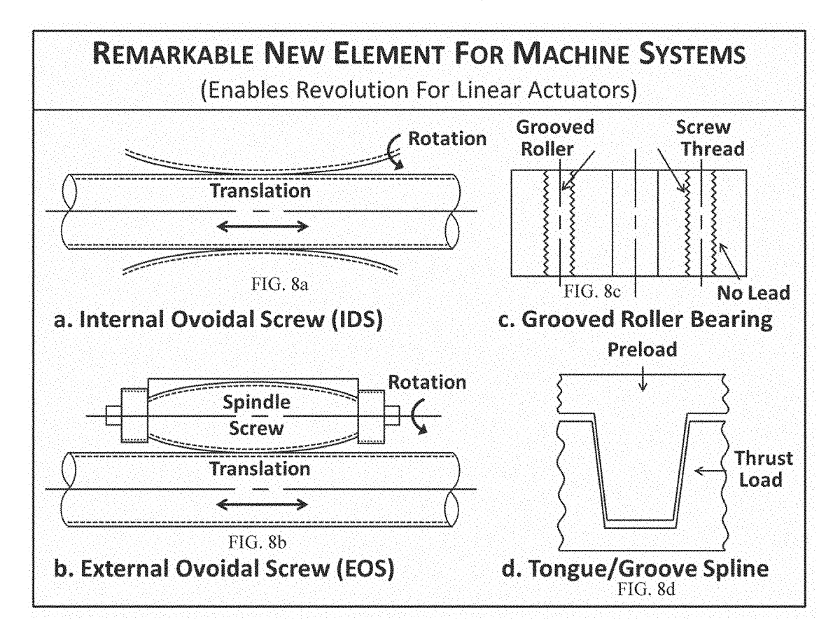

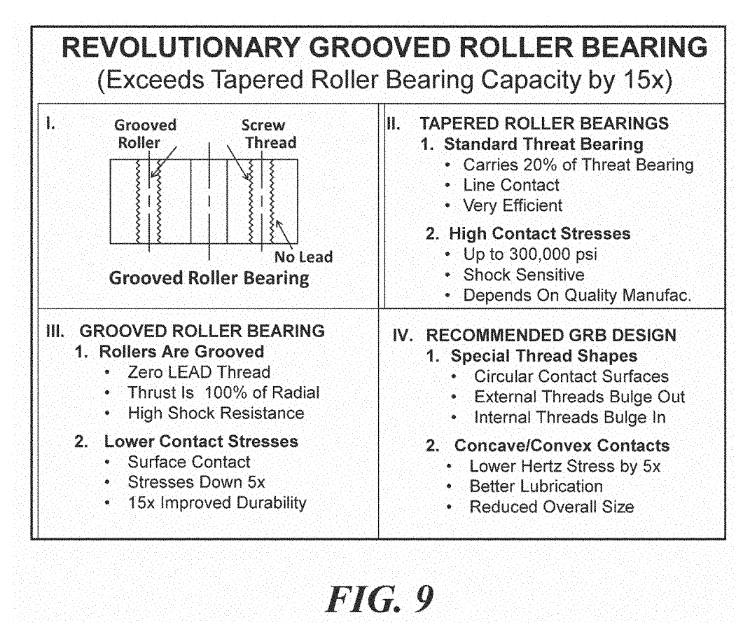

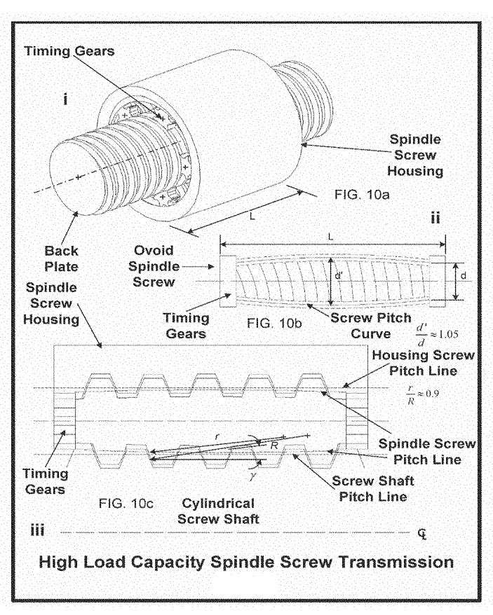

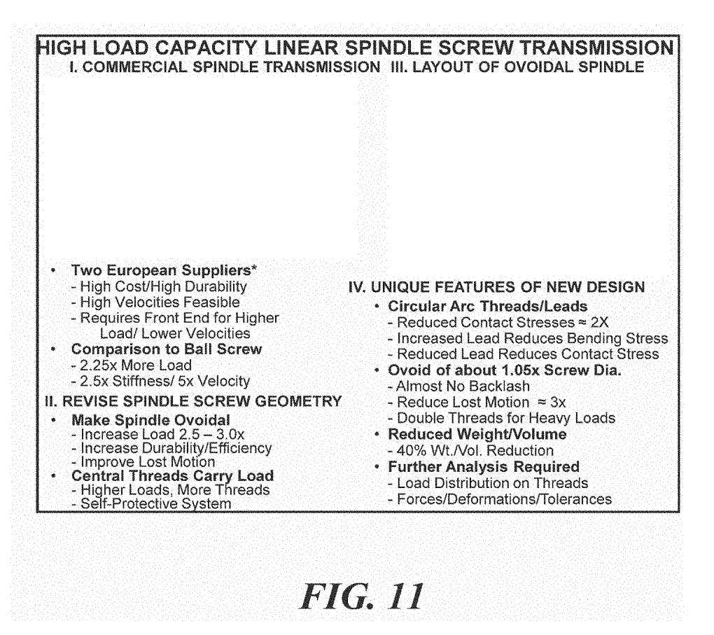

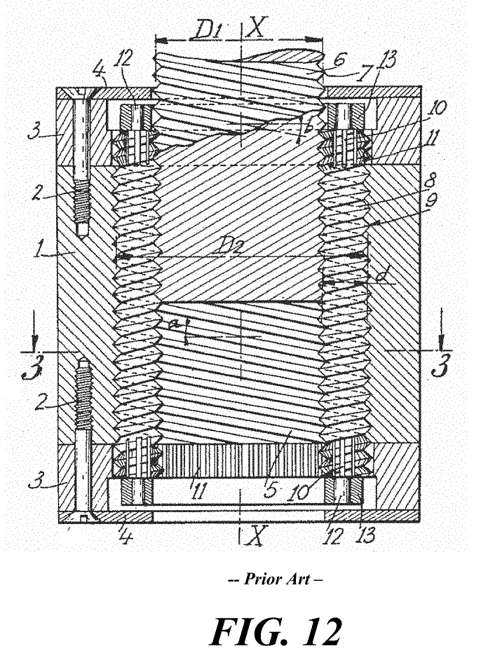

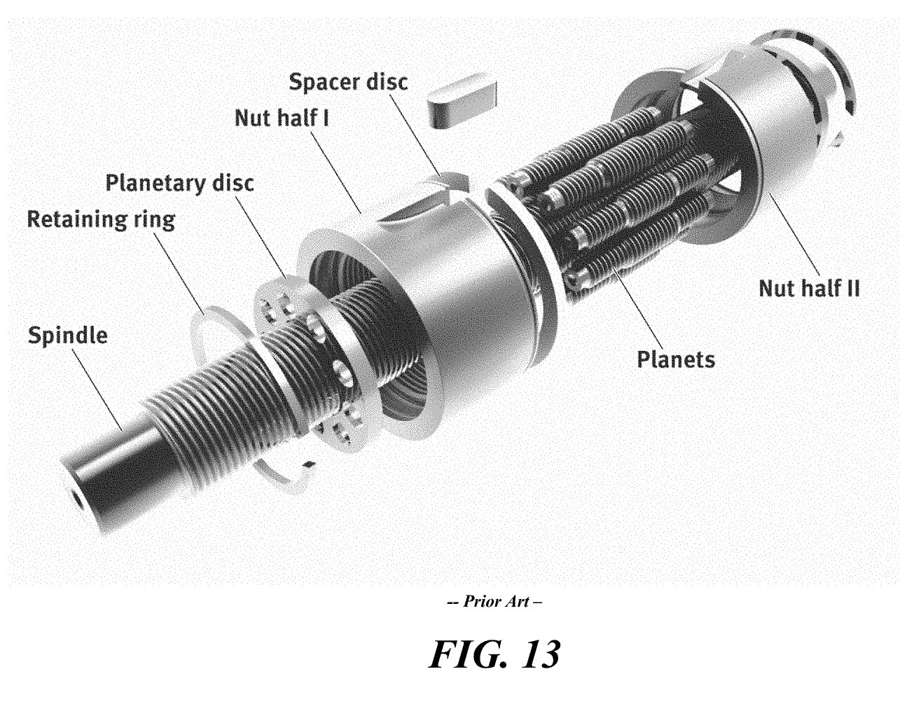

There is a basic need to provide more geometric parameters to the designer of linear actuators. FIG. 3 gives a cross-section of an augmented RPS (here labeled the ARPS) where a pair of star compound reducers symmetrically drive the planetary gear nut from the input from the rotor of the motor. The rotor contains two external gears r₁ (at each end) to drive the first gear r₂ of the star compound. Gears r₂ r₃ on the same axis are amplifier gears which then drive external gear r₄ on each end of the nut which then drives the planetary gear. Hence, four new design parameters are now available:
r₁—external gear on rotor
r₂—first amplifier gear
r₃—second amplifier gear
r₄—external gear on nut
   FIGS. 2a-2b show how these star compound gears provide some additional reduction between the rotor and the lead screw. In this case:

$$\begin{matrix}{v}_{p 1} = {r}_{1} , {ω}_{r} \\ and & ( EQUATION 8 ) \\ {v}_{p 2} = \frac{{r}_{3}}{{r}_{2}} {v}_{p 1} = \frac{{r}_{1} {r}_{3}}{{r}_{2}} = {ω}_{r} \\ but & ( EQUATION 9 ) \\ {v}_{p 2} = {r}_{4} {ω}_{n} & ( EQUATION 10 )\end{matrix}$$

such that

$$\begin{matrix}{ω}_{n} = \frac{{r}_{1} , {r}_{3}}{{r}_{2} , {r}_{4}} {ω}_{r} \\ or & ( EQUATION 11 ) \\ {ω}_{n} = {R}_{rn} {ω}_{r} & ( EQUATION 12 )\end{matrix}$$

Now the total reduction is:

Rᵣₛ=Rₙₛ×Rᵣₙ (EQUATION 13)

Such that,

$${R}_{rs} = \frac{{r}_{1} {r}_{3}}{{r}_{2} {r}_{4}} \times \frac{{4}_{π} ( {r}_{s} + {r}_{p } )}{{n}_{s} {𝓁}_{s} ( {r}_{s} + 2 {r}_{p} )} \qquad ( EQUATION 14 )$$

Generally, Rᵣₙ≈5. Hence, given Rᵣₛ≈50, then a total reduction of 250 can be achieved. Consequently, a very wide range of reduction ratios for the ARPS becomes available to meet a very wide range of application requirements.

TABLE 1 lists 4 key benefits represented by the RPS actuator relative to the standard (but parametrically sparse) Standardized Planetary Screw (SPS), and TABLE 2 lists some of the benefits of RPS and ARPS actuators.

TABLE 1
Rugged Planetary Screw (RPS) Technology
(vs. The Standard Planetary Screw (SPS), Pat. 1954)

| Topic | Description | Benefit |
|---|---|---|
| 1. Parametric | Seven vs. Three Geometric | Expanded Range of |
| Density | Parameters | Motion, Speed, Loads, |
| | | Power/Force Density |
| 2. Shorter Force | GRB Through Planet | Reduces Deformation, |
| Path | Screw To Lead Screw | Weight, Volume |
| 3. Ovoidal Planet | Central Planet Threads | Low Loss Motion No |
| Screws | Drive Lead Screw | Backlash |
| 4. Exceptional | Dual GRBs Carry Load | High Shock Capable |
| Ruggedness | Through Stiff Nut | High Peak Forces |
| | Cylinder | |

TABLE 2
Benefits of RPS and ARPS Actuators

| Benefit | Explanation |
|---|---|
| Parametric | EQUATION 13 shows that the RPS contains 3 design parameters, |
| Density | while the ARPS contains 7. This makes it possible to meet a very |
| | wide range of application requirements as might be found in |
| | construction machinery, in surgery, in aircraft, etc. These |
| | requirements include reduction ratio range of the output motion, |
| | prime mover speeds, overall actuator weight (power/force density), |
| | internal effective inertia for responsiveness, etc. |
| Shorter Force | The revolutionary high thrust load grooved roller bearing (GRB) is |
| Path | the principle load carrier of the rugged planetary screw system. |
| | Two GRBs are placed symmetrically on both ends to share the load |
| | which is transferred through the stiff nut/rotor. This GRB is able to |
| | handle up to 15x the thrust load of an equivalent tapered roller |
| | bearing with a similar increase in stiffness. Finally, the thrust load |
| | is distributed over two GRBs for each planetary screw (perhaps 6) to |
| | result in an exceptionally rugged load transfer actuator |
| Ovoidal Planet | The SPS uses straight linear planetary screws which means that only |
| Screw | 3 to 4 threads carry 90% of the load increasing wear and |
| | deformation. Further, with load reversal, the thread forces must be |
| | transferred to the other end of the planetary screw, resulting in high |
| | lost motion (poor accuracy). The RPS uses an ovoidal screw (about |
| | 5% away from straight), the central 5 to 6 threads carry the load in a |
| | parabolic distribution with a lower per thread force and one which |
| | does not change location under load reversal. Hence, this provides a |
| | dramatically improved lost motion (perhaps 5x better than for the |
| | SPS). |
| Star Gear | Linear actuators must meet a very wide range of application |
| Reducer | Reducer requirements. Providing two symmetrical star compound |
| | reducers between the rotor and the nut provides 4 additional |
| | geometric design parameters to create the augmented rugged |
| | planetary screw (ARPS) actuator. In this case, the reduction ratio |
| | can go up to 250-to-1. Choosing between the RPS and the |
| | somewhat more complex ARPS results in a very wide range of |
| | reduction ratios to meet most application requirements. |

The Rugged Planetary Screw (RPS) actuator is made up of three readily available modules. These modules, and a description of each, is set forth in TABLE 3 below.

TABLE 3
RPS Modules

| Module | Description |
|---|---|
| Prime Mover | Either BLDC or SRM, stator (FIGS. 4a-4b |
| | [[FIG. 4]]) and rotor (FIGS. 5a-5b [[FIG. |
| | 5]]) |
| Planetary Screw | Rotary to linear transmission using |
| | planetary screws (FIGS. 6a-6b [[FIG. 6]]) |
| | meshed with non-rotating translating lead |
| | screw (3) where the nut and rotor are a |
| | solid unit. |
| Grooved Roller Bearing | Newly commercialized thrust bearing (6, |
| | 7, 8) to carry the primary load of the |
| | actuator, in this case, two symmetrically |
| | placed GRBs at each end of the RPS. |

These three modules each represent self-contained design parameters where the primary constraint is to match their physical dimensions to create a remarkably compact assembly. The stator 101 is the structural backbone of the actuator. The rotor 102 of the prime mover is rigidly part of the nut of the planetary screw transmission. Consequently, the nut contains, at each end thereof, the internal gears to drive the planetary screws and the internal grooved “thread” 108 (with no lead) mesh with the GRB rollers 106 which then mesh with the external “threads” 107 on the inner race of the GRB. This inner race 107 then is screw locked 112 with the end plate 105 at both ends of the RPS. Finally, the end plates (see FIGS. 7a-7b) are bolted to the rugged stator 101 which acts as the structural back bone of the RPS to provide exceptional rigidity.

The thrust force on the lead screw 103 is transferred through two meshes (see FIGS. 6a-6c) on the planetary screws 104 to the nut 102 which transfers the thrust load through two meshes (106, 107, 108) on the GRB rolling elements to the end plate 105 using the locking threads 112. This load transfer creates a very short load path through the transmission, which is roughly estimated to carry up to 2000 lb/lb. (force density) depending on the duty cycle and shock levels in the applied load. Altogether, the RPS is expected to carry a 1000 lb/lb. (force density) for low power dense duty cycles (i.e., those with infrequent peak forces). For power dense duty cycles, the relative size of the prime mover may need to increase.

Standard machine elements (rolling element bearings, standard screws, linear ball screws, simple journal bearings, etc.) all have value and limitations when used within advanced electro-mechanical actuators (EMA). It has now been found that requirements for torque density, efficiency, ruggedness, and other such parameters may be better met in demanding duty cycles using four new elements (internal and external ovoidal screws, grooved roller bearing, and tapered tongue/groove splines).

Unfortunately, most screw thread elements use linear meshes, which cause a very unattractive thread load distribution. Given a load, the first three threads carry 80% of the load. Reversing that load means that the three threads at the other end of the screw carry 80% of the load. During the transition, there is virtually no load resistance (that is, a high lost motion) that leads to low precision response to command (that is, there is virtually no accuracy). The ovoidal screw (see FIG. 8a) provides an internal mesh to carry the load in the center of the screw length with virtually no lost motion. The level of the ovoid (1 to 5%) depends on the application requirements at a small additional cost. The level depicted in FIG. 8a has considerable sliding friction which, if not well lubricated, may be a significant loss in efficiency to cause high contact temperature, low oil viscosity, and the threat of wear.

In order to be able to reduce the friction issue of the IOS, the EOS uses a finite number of planetary spindle screws with ovoidal shapes (See FIG. 8b). These spindle screws are constrained in a rotating cage, which then drives the translating output screw. The spindles rotate, and thus represent low contact sliding (and therefore, low friction). These spindle screws are almost as rugged as the IOS, but they are much more efficient. In exchange for some increase in cost, they provide excellent wear characteristics.

A new and remarkable bearing is now being produced in the U.S. by Creative Motion Control of Seattle, Wash. (see FIG. 8c). This grooved roller bearing may be thought of as a spindle screw transmission with no lead. Each spindle becomes a rolling element that can equally carry radial and thrust loads of real magnitude. In this respect, the grooved roller bearing supersedes the excellent cross-roller bearing (at lower cost and much broader application potential, and is a key to making some of the major advances in linear electro-mechanical actuators that are described herein.

The grooves in the GRB are not straight sided to result in line contact. The rollers have circular arc thread sides (bulged out), while the races have matching shapes (indented in) to permit surface contact and higher load capacity and higher stiffness in comparison to regular shaped threads.

The concept of a tapered wedge tongue/groove spline is depicted in FIG. 8d. In the particular embodiment depicted, the taper is about 7°, enabling a single but effective preload to eliminate backlash (with virtually no lost motion). The thrust load is perpendicular to the length of the groove. This element works only if it can rapidly oscillate in short strokes in the direction of the groove. If it is well lubricated, friction losses will be near 5% (higher than the 1% for rolling element bearings). This friction loss penalty is acceptable because of the significant benefits of compactness and shock resistance in a load path as used in the cross links in parallel eccentric actuators. This compactness leads to high torque density in duty cycles for heavy machinery that experiences a lot of load shocks (i.e., earth excavators). These splines are less desirable in power duty cycles where high loads and high cyclic speeds are involved (i.e., in industrial robots).

A further aspect of a preferred embodiment of the devices disclosed herein is their use of grooved roller bearings. One of the realities of all heavily loaded systems is the need to provide low friction bearings on all axles/shafts to maximize efficiency and to permit the essential relative motion between contact surfaces. This is especially true for vehicle axle bearings and for actuator drives joints. A new rolling element bearing now promises to improve bearing durability by up to 15× relative to the standard dual tapered roller bearing.

As noted above, a quality planetary screw has been developed for linear transmissions to replace the linear actuation provided by hydraulic cylinders. These transmissions are much more energy efficient than their hydraulic cousins. Because they are driven by electric prime movers, they are superior to hydraulics in their accurate and timely response to command, providing a clean motion with virtually no backlash and low lost motion.

The 10+ planetary screws surround the central screw shaft in a nut driven by the electric prime mover. The rotation of the nut drives the screw shaft forward based on the lead of the screw (for example, the nut may have 10 threads per inch, yielding 0.1 inch per nut rotation). Each planet screw is timed with a gear meshing with an internal gear at one end of the nut. This system requires a specialized cutting system to manufacture the screws, provide for their assembly, and certify their dimensions. Material surface finish and lubrication are also important considerations. Size-wise, the units carry very large loads with a durability (and cleanliness) that exceeds hydraulic cylinders.

Tapered roller bearings were first developed by Timken in the U.S. about 1900. Putting two tapered roller bearings with opposing tapers on the same axle provides an axial load capacity of about 20% of the radial load capacity. Each roller provides a line contact at the inner and outer race. Given ten rollers, about three rollers share the whole load. Contact stresses can go up to 300,000 psi. These bearings are remarkably efficient because of the line contacts. Heavy shocks can, however, indent the line contact, thus initiating a progressive failure, as represented by vibration noise, surface pitting, and an eventual rise in temperature. The traditional aura associated with these tapered roller bearings is that they are the best, and that no further creative efforts will make them substantially better. Hence, most work now concentrates on lubrication, specialized materials, surface finish, accurate manufacture, and inspection and calibration.

All the quality properties associated with making tapered roller bearings have been applied to making the planetary roller screw. To make that concept into a bearing, the screw lead is taken to zero, and the timing gears at the end of each planet screw are removed. With these modifications, the system is no longer a screw, but a device in which the rolling elements move concentrically about a central axis (of the bearing) with no linear motion along that axis.

This new rolling element bearing has some remarkable properties. For example, the threads of the rolling elements mesh with the threads of the previous screw shaft, which now has no lead. This means that every planet “thread” is a cylindrical shape around its axis of rotation. This cylindrical shape meshes with its mating cylindrical shape to provide a sizable area of contact (not a line contact) which can carry much higher loads according to the Hertz contacting surface. The thread cylinders of the rolling planet elements that mesh with the internal “nut thread” cylinders have a remarkably reduced contact stress of 5× (according to the Hertz formula) relative to line contact. The external “shaft thread” cylinders, combined with the planet thread cylinders, probably operate at ⅓ the stresses for line contact un-tapered rolling element bearings. All of this leads to a parametrically documented estimate of a 15× longer durability for the same size bearing and load capacity.

Every vehicle typically has at least 4 critical axle bearings, all of which represent single point failures. The GRB offers an extended life of 15× over the tapered roller bearing, so its potential for single point failures is reduced considerably. Further, the GRB will handle an axial load equal to its radial load, which has real value for vehicles navigating turns at speed. Finally, the grooved mesh provides an area contact which does not indent under shock. That indentation is the initiator of failure in heavily loaded bearings. For these reasons, the Creative Motion Control grooved roller bearing deserves immediate consideration for vehicle modernization. The GRB also is of high value as principal load bearings in both rotary and linear electro-mechanical actuators.

A further goal of the present disclosure relates to spindle screw transmissions. In particular, it is a goal of the present disclosure to increase the load capacity of commercially available spindle screw transmissions by up to three times, while also improving their efficiency, durability and ruggedness. This improved transmission would then be available as a central technology for a wide range of linear electro-mechanical actuators.

At present, the existing commercial roller screw drive is produced by one U.S. and two European suppliers. It has numerous attributes which make it very competitive with hydraulic actuators in terms of load capacity, and it exceeds the functional properties associated with linear ball screws. Spindle screws in a cage/housing, (see FIG. 6) are driven by a prime mover to rotate while in mesh with a non-rotating central screw shaft. The central screw shaft is then forced to move linearly relative to the housing. In order to make these spindle screws as low cost as possible, they resemble carefully made machine screw threads as would be found on bolts used to hold machine elements together. These screw threads exist on a straight cylindrical shaft and have a straight cylindrical pitch surface (similar to the pitch circle for gear teeth). Further, the screw threads generally are straight sided with various enclosed angles between the sides (say 30°), making the pressure angle between the mating screw surfaces 15°. This pressure angle creates a separating force of 25% of the driving force, and therefore increases the normal contact surface force. The unique attribute of the motion of these spindle screws is that they largely roll on the non-rotating central screw shaft (here, it is noted that it is possible to have the prime mover drive the screw shaft while the housing remains fixed). Usually, pure rolling motion occurs only at the pitch cylinder (half-way along the screw surface between the root and the tip), while a small sliding component occurs elsewhere along the mating straight sides of the screws (resulting in some friction losses).

Perhaps the most unattractive aspect of this straight spindle screw geometry is that only a few screw threads carry the load. Usually, the first three threads on one end carry the load in one direction and, when the load reverses, the first three threads on the other end carry the load due to the local deformations of the mating threads. This leads to considerable lost motion (not backlash) during load reversals (a relatively low spring constant). Most damaging, however, is that perhaps only 30% of the threads are able to carry the load, making the transmission longer, less compact, and heavier than necessary.

It is proposed to change the geometry of the meshing screw threads (using circular arcs for their contact surfaces; see FIG. 8c) to make the threads more robust (to look more like ACME threads) and to cut the spindle screw threads on an ovoid cylinder (see FIG. 8b). The circular arc surface mesh will be a mating of a concave (radius R) surface with a convex (radius r) surface along the pitch surface, giving relatively low Hertzian stresses while ensuring almost perfect rolling contact. The surface contact normal containing the radii r, R (where r/R≈0.9) defines the pressure angle γ with the spindle screw centerline. It is desirable to make γ as small as possible to reduce the expanding forces in the mesh. The threads are made purposely “thick” to give them improved bending stiffness. Also, because of the ovoid shape of the spindle screw, the unloaded thread contact will occur in the center of the length of the spindle screw. As the load increases, more threads will come into mesh on both sides of the center of the spindle screw. The ovoid proportion (d′/d≈1.05) is chosen to ensure that all threads carry a portion of the load when maximum load capacity is required. This is achieved by the deformation of the threads (which may be a few thousandths of an inch) such that the outer threads may carry 50% of the load carried by the central threads. These threads should be more efficient (less sliding friction) when heavily loaded than those in the commercially available systems. Because of the fully shared loading in the mesh, it should be possible to increase the load capacity of the transmission by three times. Also, this shared loading should make it much more shock resistant and durable. Given a maximum deformation of the mesh of, say, 0.003″, a tolerance requirement of 0.0003″ (10× better) may be expected for these shared loads to be properly distributed. The lost motion (overall stiffness) of this class of transmission should be superior to that of the commercial device. Of course, one skilled in the art will appreciate that this design will be somewhat more expensive, and that there may be a greater need to use timing gears to maintain spindle screw alignment at higher operating speeds.

### Ovoidal Screws

The devices disclosed herein preferably utilize ovoidal planetary screws to enhance performance of the linear planetary screw transmission. These screws may be manufactured at relatively low cost by adapting a standard screw cutting machine with simple cutters to automatically mass produce the ovoid planet screw.

Linear planetary screw transmissions have a much higher overall performance (in terms of stiffness, lost motion, noise, load capacity, and various other parameters) than standard ball screws. The manufacture and market acceptance of these transmissions is now a question of quality, and the ability to certify and deliver these transmissions on a timely basis and at a competitive price. Both the ball screw and the existing planetary screw transmissions, however, suffer from severe lost motion in crossover loading (that is, high load reversals). Given twenty threads in the screw mesh, the end thread may carry 40% of the load, the next 25%, the next 15%, and so forth. This means that fifteen of the threads are largely unused. When the load reverses, the first 4 to 5 threads on the other end of the screw now must carry the load. In order to transition during load reversal, the deformation must shift from one end to the other (a relatively large free motion) with virtually no load carrying capacity during the deformation shift. This manner of operation is very destructive to precision or high accuracy operations.

By contrast, if the planetary screws are ovoidal, then the central screw threads in the middle of the planet screw carry the principal load (see FIG. 10c), thus eliminating any deformation shift. Furthermore, depending on the ovoidal shape (say, from 1% to 5%), more or fewer threads would carry the load. This question of distribution may require a rather simple finite element analysis to determine the best percentage in the ovoid for a given application. This means that, for a high ovoidal percentage (say, 5%), fewer threads would be engaged to result in less lost motion, but with lower stiffness and load capacity, and vice versa. Given the potential to create a unique product for the market (to solidify a brand name), it is desirable to mass produce these planet screws at an acceptable cost. The benefits would enable the producer to claim a premium price for perhaps 10% of the linear transmission applications.

It is clear that ovoidal planetary screws are a very distinct component for an otherwise unchanged linear screw transmission. Hence, this poses the issue of how to cost effectively manufacture these ovoidal planet screws in quantity. Unfortunately, these planet screws must be long and relatively small in the principal diameter, which means they may deform somewhat under the cutting loads. Speed of cutting and metal removal means higher loads, which implies more time and higher cost. It is suggested to specify a cutting head to cut 2 to 4 threads as the head moves along the length of the ovoid planet screw. The threads would be circular arc in shape (not straight sided). The planet threads would be bulked out, while the nut threads would be slimmed. This combination means that the threads can carry 2-3 times the normal load, with perhaps 2× less deformation. Since the load carrying threads are centered along the length of the planet screw, load and stiffness also go up by 2×, while lost motion goes down dramatically. All of these benefits may result in a premium high-end linear transmission.

Generally, screws are made on a machine where a cutting head traverses the screw at a fixed rate while the screw rotates to result in the lead of the screw. The traverse is along a straight line parallel to the centerline of the screw. Here, the traverse would be along a curved to form the ovoid for the screw. The rate of travel along the center line of the screw would be constant relative to the rotation of the screw (i.e., the screw lead).

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims. It will also be appreciated that the various features set forth in the claims may be presented in various combinations and sub-combinations in future claims without departing from the scope of the invention. In particular, the present disclosure expressly contemplates any such combination or sub-combination that is not known to the prior art, as if such combinations or sub-combinations were expressly written out.

1. A planetary screw actuator, comprising:
a stator;
a rotor;
a lead screw having external threads thereon;
an ovoidal planet screw that meshes with the external threads on the lead screw;
an end plate; and
a grooved roller bearing (GRB) race disposed between said end plate and said ovoidal planet screw, said GRB race having at least one GRB roller disposed therein.

2. The planetary screw actuator of claim 1, further comprising a nut, and wherein said ovoidal planet screw meshes with the internal threads on the nut.

3. The planetary screw actuator of claim 2, wherein said ovoidal planet screw meshes with the external threads of the translating output lead screw with a lead of lₛ.

4. The planetary screw actuator of claim 1, further comprising a nut disposed between said endplate and said rotor.

5. The planetary screw actuator of claim 4, wherein said nut is disposed between said GRB race and said rotor.

6. The planetary screw actuator of claim 4, wherein said rotor and said nut form a monolithic construction.

7. The planetary screw actuator of claim 4, wherein said rotor and said nut are distinct.

8. The planetary screw actuator of claim 1, wherein said ovoidal planet screw has first and second opposing ends, and further comprising a first grooved roller bearing disposed on said first end of said ovoidal planet screw.

9. The planetary screw actuator of claim 8, further comprising a second grooved roller bearing disposed on said second end of said ovoidal planet screw.

10. The planetary screw actuator of claim 9, wherein said stator is rigidly attached to said end plate.

11. The planetary screw actuator of claim 10, wherein said rotor is disposed between said ovoidal planet screw and said stator.

12. The planetary screw actuator of claim 1, wherein said ovoidal planetary screw has a rotational axis of symmetry about its longitudinal axis.
